(19) United States
(12) Patent Application Publication
(10) Pub. No.: US 2021/0217066 A1
(43) Pub. Date: Jul. 15, 2021

(54) systems and methods for an interactive tattoo estimator and scheduler

(71) Applicant: Grapes Wasserman, West Hollywood, CA (US)

(72) Inventor: Grapes Wasserman, West Hollywood, CA (US)

(21) Appl. No.: 17/146,379

(22) Filed: Jan. 11, 2021

Related U.S. Application Data
(60) Provisional application No. 62/959,291, filed on Jan. 10, 2020.

(51) Int. Cl. G06Q 30/02; G06Q 10/10; G06N 20/00

(52) U.S. Cl. CPC G06Q 30/0283; G06N 20/00; G06Q 10/1095

(57) ABSTRACT

A system and method for an interactive tattoo estimator and scheduler is disclosed. The system includes a server configured to generate a 3-D virtual body model configured to support presentation of user desired tattoo designs on the virtual body model that resembles the dimensions of the user. The system is further configured to determine quotes associated with tattoo artists rendering the user desired tattoo designs based on the portion of the virtual body model representing where the tattoo design is to be rendered. The system further is configured to allow the user to select the estimate that best reflects the user's preferences and schedule a booking for rendering the tattoo.

### CROSS REFERENCE TO RELATED APPLICATIONS

This patent application claims the benefit of U.S. Provisional Application. No. 62/959,291, entitled SYSTEM FOR AN INTERACTIVE TATTOO ESTIMATOR AND SCHEDULER AND METHOD THEREOF filed Jan. 11, 2020. The entire content of 62/959,291 is hereby incorporated by reference.

### BACKGROUND OF THE INVENTION

### 1. Field of the Invention

The present invention relates generally to systems and methods for generating an art quote, and more particularly to a system and method for an interactive tattoo price estimator and appointment scheduler.

### 2. Description of the Related Art

A tattoo is considered an artistic expression requiring modification to a portion of an individual's skin made by inserting ink, dyes, and pigments into the dermis layer of the skin resulting in the pigment changing. Ordinarily when choosing a design for a tattoo, the individual either already has a design in mind or browses through countless sources in order to determine the desired artwork to embed on their skin. Due to the permanent nature of tattoos, individuals are typically very selective of the tattoo artist who administers the tattoo due to the fact that each tattoo artist has distinct styles, methods, and requirements that have a significant impact on the final presentation.

In addition, factors such as the reputation of the tattoo artist, complexity of the design, area (body part) where the design is to be applied, level of difficulty associated with application, and many other applicable factors determine the overall cost of a tattoo. However, an individual who is shopping for a tattoo must currently utilize a significant amount of time and energy searching for a reputable tattoo artist that will render the desired design at the highest caliber. Also, a common approach in tattoo shopping is for the individual to view other tattoos rendered by a particular tattoo artist in order to determine if the particular tattoo artist has the capability to render the desired design. This approach requires the individual to take the time to physically meet each tattoo artist for a consultation or browse through each tattoo artist's personal catalogue. Nonetheless, this approach not only fails to provide the individual with a preview of the design on their body in a particular area, but also this approach fails to efficiently take into consideration the aforementioned factors that affect the overall cost of rendering the design.

Accordingly, a system and method are needed to address the shortfalls of the present technology; in particular, a system and method for an interactive tattoo estimator and scheduler is needed in order for an individual to preview a design on a particular body part and solicit multiple quotes from tattoo artists to render the design on the particular body part.

### SUMMARY OF THE INVENTION

The present disclosure is directed to systems and methods for an interactive tattoo estimator and scheduler, substantially as shown in and/or described in connection with at least one of the figures, and as set forth in the claims and detailed description of the drawings.

In one aspect, the present disclosure is embodied as a system including a non-transitory memory storing an executable code and an artist information database, a hardware processor executing the executable code where the executable code receives at least one tattoo parameter input from a user or client, determines an artist rate based on one or more artist specific prices in the artist information database and determine a quote price based on the tattoo parameter and the artist rate. In one embodiment, the tattoo parameter is a tattoo style, a tattoo size, a tattoo location on a body, a tattoo percent body area, a tattoo body partition, a tattoo body partition selected from a pre-partitioned virtual body model, a tattoo body partition selected from a pre-partitioned 3-dimensional virtual body model, and/or a tattoo body percent unit.

In one embodiment of the present disclosure the artist information database includes an artist hourly rate, an artist style, an artist estimate for a tattoo, an artist estimate for a style specific tattoo, an artist percent rate, an artist time to complete a tattoo body percent unity, an artist availability, an artist location, an artist review, an artist sample work, an artist portfolio, an artist deposit requirement, an artist instruction, and/or an artist biography or other artist relevant information.

In one aspect of the present disclosure, the non-transitory memory of the system also stores a tattoo library database which includes at least one tattoo sample, a predetermined tattoo style, a predetermined tattoo size, and/or a predetermined tattoo percent body area. Here, the hardware processor executing the executable code determines an artist rate for a percent unit based on the artist style price estimate for the tattoo sample and the predetermined tattoo percent body area. The hardware processor executing the executable code also determines an artist time for a percent unit based on one or more artist style price estimate for the tattoo sample and an artist hourly rate.

In another embodiment, the disclosure is embodied as a system for estimating a tattoo quote and facilitating scheduling between a client and an artist. The hardware processor executing the executable code can determine an artist rate for a percent unit based on an artist style price estimate for the tattoo sample and the predetermined tattoo percent body area, and the hardware processor executing the executable code further determines an artist time to complete a percent unit based on one or more artist style price estimate for the tattoo sample and an artist hourly rate. The hardware processor executing the executable code also determines the quote price based on the artist rate for a percent unit, the artist time to complete a percent unit, the given tattoo parameter and the artist rate. In yet another embodiment, the hardware processor executing the executable code can receive an artist estimate for a given tattoo size and style and determines an artist rate for a percent unit. Whereas in other embodiments, the hardware processor executing the executable code also receives an artist estimate for a given tattoo size and style and determines an artist time for a percent unit. In another embodiment, the hardware processor of the system executing the executable code also receives a tattoo parameter, determines a specific tattoo quote based on the tattoo parameter, the artist time for a percent unit and the artist rate for a percent unit and outputs the specific tattoo quote on a display. In addition, the hardware processor executing the executable code of the system can the artist to accept or decline a user's request or client's request.

In another embodiment, the disclosure is embodied as a system including a non-transitory memory storing an executable code and an artist information database, a hardware processor executing the executable code which receives at least one art parameter input from a user, determines an artist rate based on one or more artist specific prices in the artist information database and determines a quote price based on the art parameter and the artist rate. This can be done for murals, paintings, flooring, home and/or office design, custom jewelry or any other artistic expression where pricing depends on the artist's rate, the style of the art, size of the art and time it would take to accomplish a particular art work. In some embodiments, the hardware processor executing the executable code also receives an art parameter, determines a specific art quote based on the art parameter, the artist time for a percent unit and the artist rate for a percent unit and outputs the specific art quote on a display for a more accurate quote for a given project or work.

In accordance with one form of this disclosure, there is provided a method for use with a system including a hardware processor and a non-transitory memory, the method includes the steps of receiving, by the hardware processor, a tattoo parameter, receiving, by the hardware processor, an artist rate, and transmitting, using the hardware processor, a quote price based on the tattoo parameter and the artist rate.

In one embodiment, the method also includes a client computer and also includes the steps of receiving, using the hardware processor, information describing at least one tattoo style, transmitting, using the hardware processor, estimated prices for a size of at least one of the tattoo styles, receiving, using the hardware processor, a request originated by a prospective tattoo recipient device for a tattoo style and a tattoo size, and transmitting, using the hardware processor, a message one of accepting or declining the request. In another embodiment, the tattoo size is input by selecting a body area on a pre-partitioned virtual body model or pre-partitioned 3D body model. The method can also include the steps of determining an artist rate for a percent unit, using the hardware processor via dividing an estimated cost of the artist's services by a percentage of a sample of the body area of the tattoo, determining an artist time for a percent unit, using the hardware processor, via dividing the average of the plurality of the artist rates for a percent unit, determining a time associated with rendering the tattoo style, using the hardware processor, by multiplying the artist time for a percent unit by a percentage of the body area of the tattoo received from a recipient device, and transmitting a final quote to the computing device from the artist using the hardware processor, where the final quote is the hourly rate of the artist multiplied by the total of the artist rate for the percent unit. In an alternative embodiment, the method also includes the step of transmitting, using the hardware processor, a message one of accepting and declining the request. In yet another embodiment, the method also includes the step of providing, using the hardware processor, additional information comprising at least one of hourly rates, deposit requirement, aftercare instructions, and biographical information.

In one embodiment, the system and method of the present disclosure utilizes machine learning and also includes the steps of storing training data that comprises a plurality of training instances, each of which includes a plurality of feature values and a label that indicates whether the training instance pertains to the tattoo artist and tattoo style, and using one or more machine learning techniques to train a classification model based on the training data. This allows the system to more accurately determine styles, prices and quotes for artwork and tattoos and aids in creating more accurate quotes and seamless interactions between a user and an artist and helps schedule artwork and tattooing sessions.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims. The foregoing and other features and advantages of the present invention will be apparent from the following more particular description of the preferred embodiments of the invention, as illustrated in the accompanying drawings.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

The accompanying drawings, which are incorporated in and constitute part of this specification, illustrate embodiments of the disclosure and together with the description, serve to explain the principles of the disclosed embodiments.

FIG. 1 shows a diagram of an exemplary operating environment of a system for an interactive tattoo estimator and scheduler, according to one implementation of the present disclosure.

FIGS. 2A-2D show an exemplary user interface for providing a reference image in the system for an interactive tattoo estimator, according to one implementation of the present disclosure.

FIG. 3A and FIG. 3B show an exemplary user and client interface depicting a virtual body model in the system for an interactive tattoo estimator and scheduler, according to one implementation of the present disclosure.

FIG. 4A shows an exemplary user interface depicting a tattoo artist services representation in the system for an interactive tattoo estimator and scheduler, according to one implementation of the present disclosure.

FIG. 4B shows an exemplary user interface depicting a booking request, according to one implementation of the present disclosure.

FIG. 5 shows an exemplary artist interface depicting an artist artwork and portfolio in the system for an interactive tattoo estimator and scheduler, according to one implementation of the present disclosure.

FIG. 6 shows an exemplary artist interface and an artist quote tool in the system for an interactive tattoo estimator and scheduler, according to one implementation of the present disclosure.

FIG. 7 shows an exemplary user interface depicting a tattoo artist profile in the system for an interactive tattoo estimator and scheduler, according to one implementation of the present disclosure.

FIGS. 8A-8B show a flowchart illustrating an exemplary method of providing an interactive tattoo estimator and scheduler on the user side, according to one implementation of the present disclosure.

FIG. 9 shows another flowchart illustrating an exemplary method of providing an interactive tattoo estimator and scheduler on the tattoo artist side, according to one implementation of the present disclosure.

FIG. 10 shows a block diagram illustrating a computer system according to exemplary embodiments of the present disclosure.

FIG. 11 shows another block diagram illustrating a computer system according to one embodiments of the present disclosure.

FIG. 12 shows another flowchart illustrating an exemplary method of providing an interactive tattoo estimator and scheduler on the tattoo artist side, according to one implementation of the present disclosure.

FIG. 13 shows a flowchart illustrating an alternative embodiment of a method according to one implementation of the present disclosure.

FIG. 14 shows a flowchart illustrating another embodiment of a method according to another implementation of the present disclosure.

FIG. 15 shows a flowchart illustrating yet another embodiment of a method according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

The disclosed embodiments improve upon problems with the prior art by providing a system and method for an interactive tattoo estimator and scheduler configured to receive a user's desired tattoo parameters including style of a tattoo and size of a tattoo and utilizes a fragmented and pre-partitioned three-dimensional virtual body model configured to accurately estimate the style, size and time it would take an artist to complete a given tattoo and transmits a quote based on the artist hourly rate, artist time to complete a percent body unit for a given style and an artist rate to complete a percent body unit for given tattoo parameters.

The system further provides a centralized platform for users wishing to receive a tattoo to transmit requests based on the style and size of the tattoo and receive quotes from various tattoo artists for the cost of their services to render the particular tattoo. Finally, the system improves the overall tattoo shopping experience by providing a personalized 3-dimensional interactive representation configured to allow the user to preview various portrayals of tattoo parameters, receive quotes for rendering the design, scheduling the design, and the ability to accomplish the aforementioned from the comfort of their computing device.

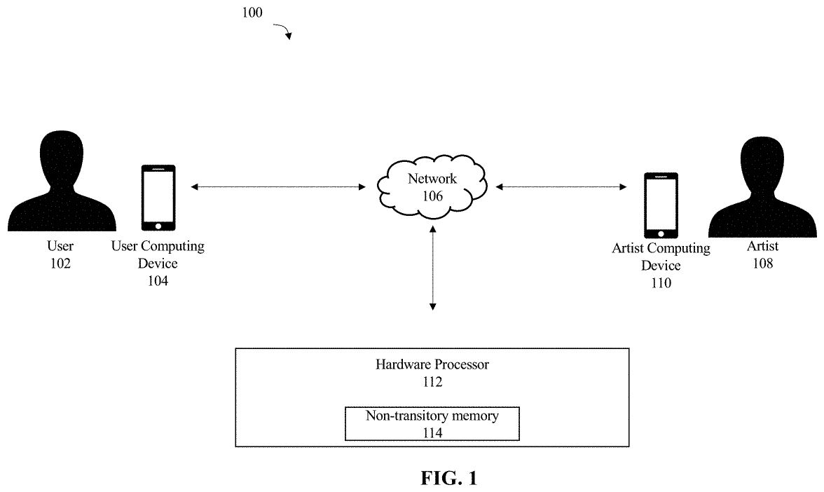

Referring now to FIG. 1, a system for an interactive tattoo estimator and scheduler 100 is depicted, according to an example embodiment. System 100 comprises a user 102 operating on a user computing device 104 in which computing device 102 is communicatively coupled to a communications network 106, such as the internet. Here, an artist 108 operates on one side of the system 100 and on an artist computing device 110. The system also includes a hardware processor 112 and a non-transitory memory 114. In one embodiment, the artist 108 may transmit and receive a plurality of interactive interactions with a user 102 via a centralized platform operated by a hardware processor 112 and a non-transitory memory 114 over network 106. The hardware processor 112 in some embodiments may be a collection of one or more servers of hardware and software configured to communicate with each computing device of system 100 over network 106. The centralized platform may be software and/or a mobile application with functionality provided by a hardware processor 112 configured to continuously collect and transmit data associated with each applicable component of system 100 in real time. For example, user computing device 104 and artist computing device 110 may be configured to initiate communicative sessions with each other in which user 102 may provide an inquiry and artist 108 may respond to the inquiry with one or more estimates associated with rendering the tattoo. In one embodiment, the hardware processor 112 and the non-transitory memory 114 are configured to host at least a chat message portal and/or a telecommunication session configured to allow user 102 and artist 108 to communicate in real time over network 106 once a booking has been scheduled for the services of the artist 108.

In one embodiment, data communicated on network 106 can be implemented using a variety of protocols on a network such as a wide area network (WAN), a virtual private network (VPN), metropolitan are networks (MANs), system area networks (SANs), a public switched telephone network (PTSN), a global Telex network, or a 2G, 3G, 4G or 5G network. Such networks can also generally contextually be referred to herein as the internet or cloud.

It is to be understood that system 100 and said components may be implemented in hardware, software, or a combination thereof. In some embodiments, the various components of system 100 are implemented at least partially by hardware at one or more computing devices, such as one or more hardware processors executing instructions stored in one or more memories for performing various functions described herein. For example, descriptions of various components (or modules) as described in this application may be interpreted by one of ordinary skill in the art as providing pseudocode, an informal high-level description of one or more computer structures. The descriptions of the components may be converted into software code, including code executable by an electronic processor. System 100 illustrates only one of many possible arrangements of components configured to perform the functionality described herein. Other arrangements may include fewer or different components, and the division of work between the components may vary depending upon the arrangement.

In one embodiment, the user computing device 104 may include, but is not limited to, a laptop computer, a tablet computer, a smartphone, a desktop computer, internet of things (IOT) device, and any other mechanism used to access networks and software. In one embodiment, the hardware processor 112 and non-transitory memory 114 includes an artist information database 116 where the artist information database is configured to include records holding profiles, estimates, hourly rates, reviews and ratings, tattoo styles, availability, artwork catalogue, and any other applicable data configured to promote the skills and work of the artist 108. In application, user 102 accesses the centralized platform provided by the hardware processor 112 and the non-transitory memory 114 on a user computing device 104 and provides an initial user input for tattoo or art parameters. In one embodiment, the initial user input may be one or more images or videos of user 102 or the initial user input may be a live recording of user 102 captured by at least one sensor (a camera) associated with computing device 104. The hardware processor 112 and the non-transitory memory 114 utilize the initial user input to generate a three-dimensional (3D) virtual body model configured to accurately reflect the shape, contours, and other specific features of the anatomical structure of user 102. The hardware processor 112 and the non-transitory memory 114 are further configured to partition the virtual body model based upon locations of body parts of user 102 resulting in a plurality of partitions configured to be interacted with by user 102.

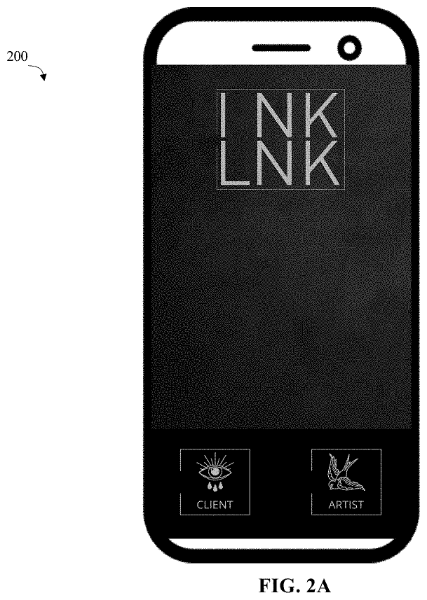

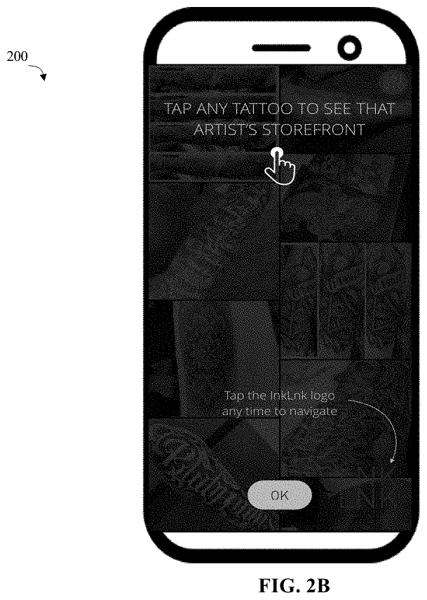

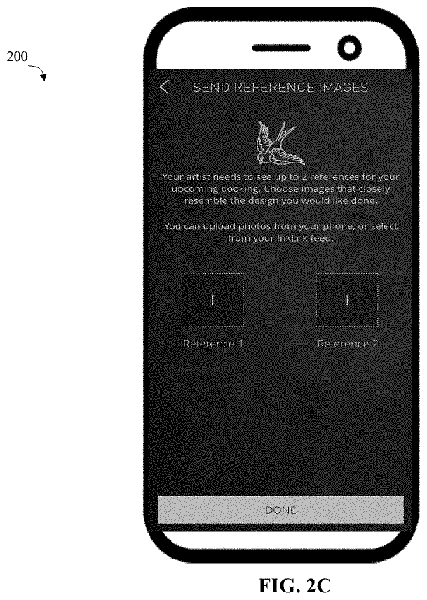

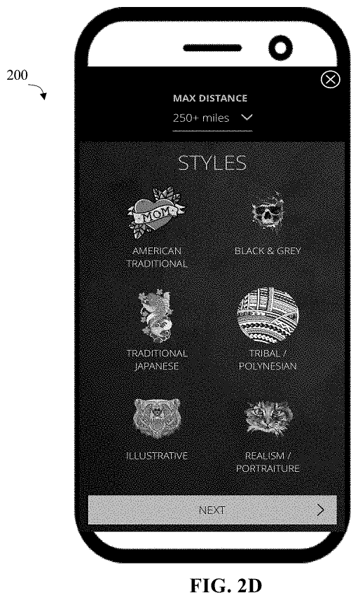

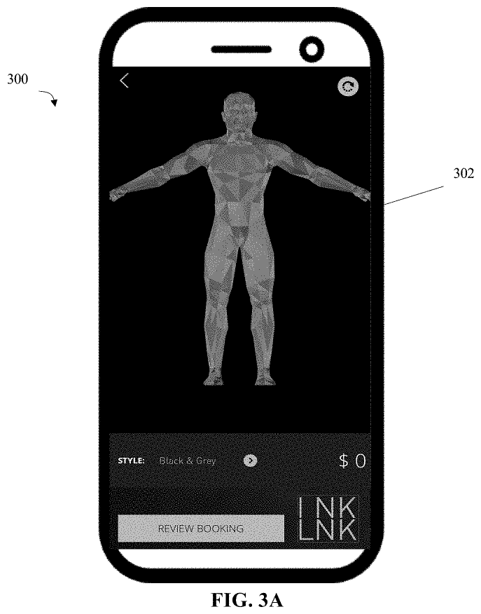

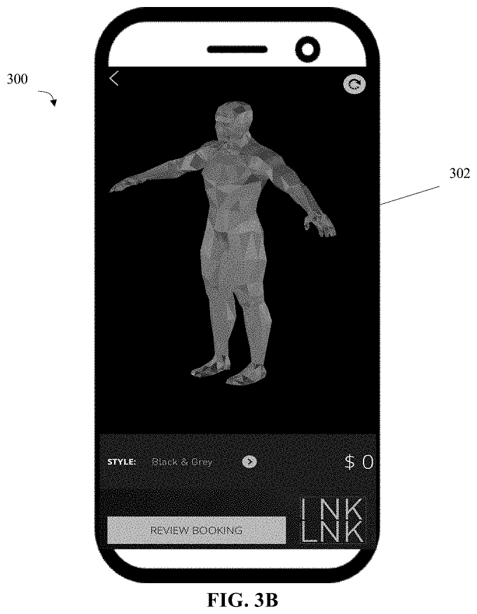

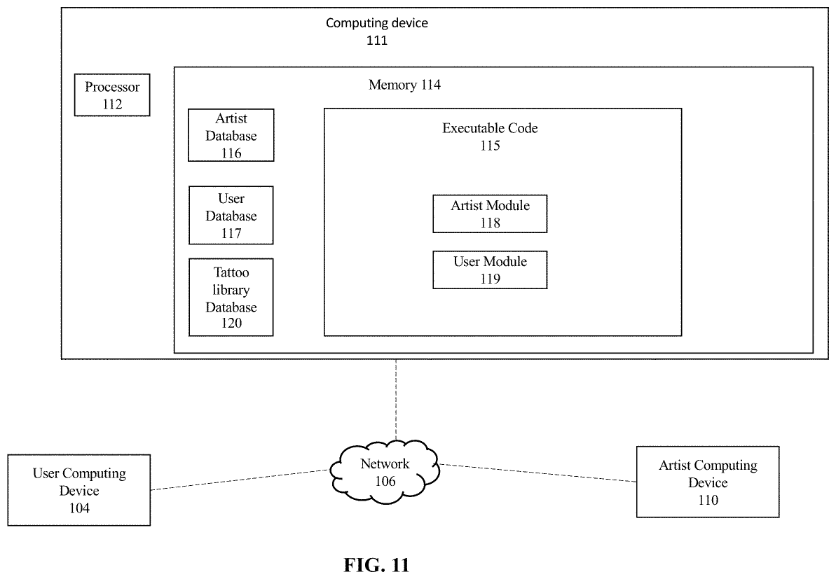

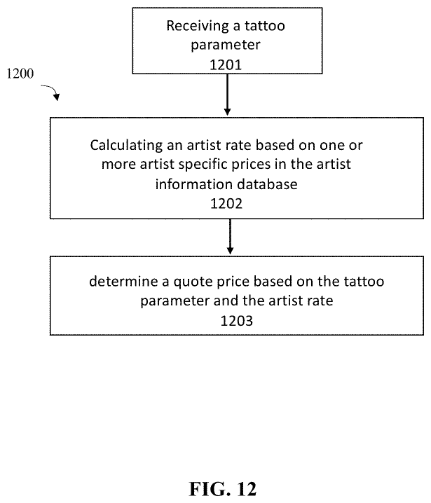

In one aspect as shown in FIG. 11, the present disclosure is embodied as a system 100 including a non-transitory memory 114 storing an executable code 115 and an artist information database 116. The hardware processor 112 executing the executable code 115 where the executable code receives at least one tattoo parameter input from a user or client 102, determines an artist rate based on one or more artist specific prices in the artist information database 116 and determines a quote price based on the tattoo parameter and the artist rate. In one embodiment, the tattoo parameter is a tattoo style 200 as shown in FIG. 2D, a tattoo size 302, a tattoo location on a body as shown in FIG. 3A and FIG. 3B, a tattoo percent body area, a tattoo body partition 302, a tattoo body partition selected from a pre-partitioned virtual body model as shown in FIG. 3A, a tattoo body partition selected from a pre-partitioned 3-dimensional virtual body model 302, and/or a tattoo body percent unit. In some embodiments, some tattoo parameters are in a tattoo library database 120 with preloaded styles, sizes, variations of the tattoo and other tattoo parameters which are in communication with an artist database 116, a user database 117, an artist module 118 and a user module 120.

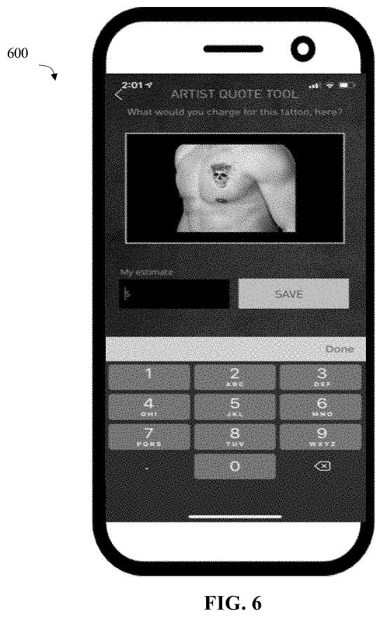

In one embodiment of the present disclosure the artist information database 116 includes an artist hourly rate, an artist style, an artist estimate 600 for a tattoo as shown in FIG. 6, an artist estimate for a style specific tattoo, an artist percent rate, an artist time to complete a tattoo body percent unity, an artist availability, an artist location, an artist review, an artist sample work, an artist portfolio, an artist deposit requirement, an artist instruction, and/or an artist biography or other artist relevant information.

In one aspect of the present disclosure, the non-transitory memory 114 of the system 100 also stores a tattoo library database 120 which includes at least one tattoo sample, a predetermined tattoo style, a predetermined tattoo size, and/or a predetermined tattoo percent body area. Here, the hardware processor 112 executing the executable code 115 determines an artist rate for a percent unit 1162 based on the artist style price estimate for the tattoo sample and the predetermined tattoo percent body area. The hardware processor 112 executing the executable code 115 also determines an artist time for a percent unit based 1163 on one or more artist style price estimate for the tattoo sample and an artist hourly rate.

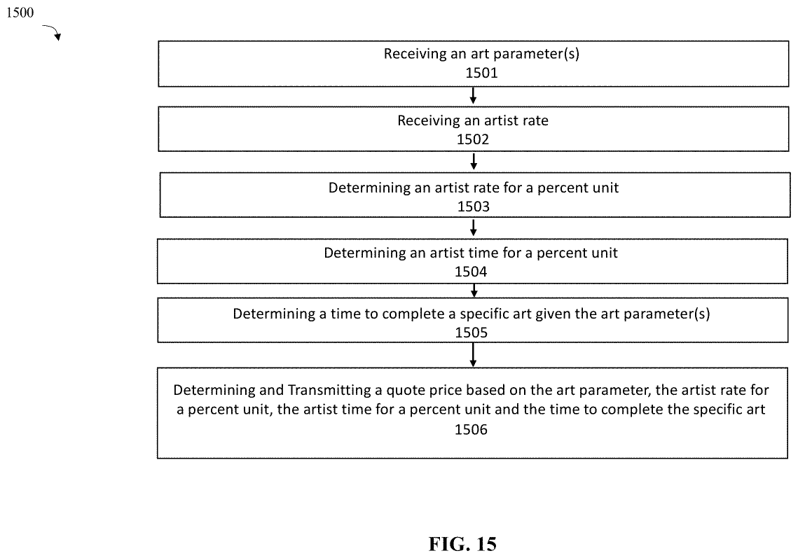

In one embodiment, as shown in FIG. 15 the system 100 receives an artist rate or artist hourly rate 1502. This is the artist's hourly rate or how much they would charge for an hour of their time. This artist rate can be style dependent or style independent. The artist may change their hourly rate on the system at any time, and the system uses the latest or appropriate artist rate if the work is style dependent. The system 100 then receives an artist input for an estimate for a given tattoo preloaded in the system with known style and known size. The known size in the system can be a percentage of the body. For example, a portion of the wrist can be the equivalent of 1.2% of the body. The system 100 then determines an artist rate for a percentage of the body or percent unit of the body that the tattoo covers, or size of the tattoo by dividing the artist estimate by the percent body size of the known preloaded tattoo. Here, the hourly rate is not used, instead, the input price estimate for the given tattoo is used. In one particular embodiment, to ensure better accuracy, the system 100 receives multiple entries and inputs from artist for a given style for a more accurate quote. The system shows a few different preloaded tattoos of either the same size or different sizes, and various complexity and styles and receives price estimate inputs from an artist. Here, the system 100 averages the price estimate of that style of tattoo based on quotes provided by the artist for a given style of tattoo and tattoos preloaded in the system so the system averages the estimate of that style of tattoo for a 1% of the body.

In another embodiment, the system 100 determines an artist time for a percent unit. Here the system determines the number of hours it would take an artist to do a 1% of the body or percent unit by taking their hourly rate for a percent unit or per 1% and that number is divided by their hourly rate to determine the number of hours to finish a percent of body. Here the artist time for a percent unit 1163 is the number of hours it would take to finish 1% of body for a given style. In one embodiment, the system receives a user input for a style and size of a tattoo or tattoo parameter 1401. The size received thanks to a pre-partitioned 3D body model determines the percent body covered by the tattoo. The system then determines how long it would take to get the tattoo done or the artist time for a percent unit. The system 100 determines how long it would take to get the given tattoo style and size by multiplying the number of hours to do a percent unit or 1% of the body by the percentage of the tattoo size. In one particular embodiment, the system 100 determines a quote for a given style and size of tattoo by multiplying the time it would take to do the tattoo or artist time rate for a percent unity by the artist hourly rate and outputs a quote for a given style and size of tattoo.

In some embodiments, an artist can have one set hourly rate for all styles of tattoos or input hourly rates depending on style of the tattoo. In one particular embodiment, the system 100 receives an artist hourly rate, receives an artist quote for a given tattoo preloaded in the system with a known size and style then the system determine an hourly rate for a percent unit of a tattoo. The system also receives an input from a user or client for a tattoo parameter. In one embodiment, the minimum tattoo parameter is a style and size, in other embodiments the minimum tattoo parameter to be received is a tattoo style and a selection of a pre-partitioned 3D body model to determine size of the tattoo. In other embodiments, the minimum tattoo parameter is a style or size. Based on the tattoo parameter received and the artist rate, the system determines an artist rate for a percent unit and/or an artist time for a percent unit. The size of the tattoo is determined using the percent body area selected by a user on a 3D body model. Here, each fragment or portion of the 3D body scan has a predetermined percent body area covered by each fragment or portion. The system then determines a quote based on artist hourly rate per percent unit and percent body selection input by user selection.

In an alternative embodiment, the system receives an artist hourly rate, an artist estimate for a given tattoo size, and the system then determines an artist hourly rate for a percent unit. The system also receives a user input for a tattoo size, here the size can either be received via a photo, video, or a selection of size input from a fragmented 3D body scan with predetermined percent body area covered by each fragment. The system 100 then determines a quote based on artist hourly rate per percent unit and percent body selection input by user selection. In some embodiments, the size of the 3D body model is changed to take into consideration a user input of height and weight.

In another embodiment, the disclosure is embodied as a system 100 for estimating a tattoo quote and facilitating scheduling between a client/a user 102 and an artist 108. The hardware processor 112 executing the executable code 115 can determine an artist rate for a percent unit based on an artist style price estimate for the tattoo sample and the predetermined tattoo percent body area, and the hardware processor executing the executable code further determines an artist time to complete a percent unit based on one or more artist style price estimate for the tattoo sample and an artist hourly rate. The hardware processor executing the executable code also determines the quote price based on the artist rate for a percent unit, the artist time to complete a percent unit, the given tattoo parameter and the artist rate. In yet another embodiment, the hardware processor 112 executing the executable code 115 can receive an artist estimate for a given tattoo size and style and determines an artist rate for a percent unit. Whereas in other embodiments, the hardware processor executing the executable code also receives an artist estimate for a given tattoo size and style and determines an artist time for a percent unit. In another embodiment, the hardware processor of the system executing the executable code also receives a tattoo parameter, determines a specific tattoo quote based on the tattoo parameter, the artist time for a percent unit and the artist rate for a percent unit and outputs the specific tattoo quote on a display. In addition, the hardware processor executing the executable code of the system can the artist to accept or decline a user's request or client's request.

In another embodiment, the disclosure is embodied as a system including a non-transitory memory storing an executable code and an artist information database, a hardware processor executing the executable code which receives at least one art parameter input from a user, determines an artist rate based on one or more artist specific prices in the artist information database and determines a quote price based on the art parameter and the artist rate. This can be done for murals, paintings, flooring, home and/or office design, custom jewelry or any other artistic expression where pricing depends on the artist's rate, the style of the art, size of the art and time it would take to accomplish a particular art work. In some embodiments, the hardware processor executing the executable code also receives an art parameter, determines a specific art quote based on the art parameter, the artist time for a percent unit and the artist rate for a percent unit and outputs the specific art quote on a display for a more accurate quote for a given project or work.

In accordance with one form of this disclosure, there is provided a method for use with a system including a hardware processor and a non-transitory memory, the method includes the steps of receiving, by the hardware processor, a tattoo parameter, receiving, by the hardware processor, an artist rate, and transmitting, using the hardware processor, a quote price based on the tattoo parameter and the artist rate.

In one embodiment, the method also includes a client computer and also includes the steps of receiving, using the hardware processor, information describing at least one tattoo style, transmitting, using the hardware processor, estimated prices for a size of at least one of the tattoo styles, receiving, using the hardware processor, a request originated by a prospective tattoo recipient device for a tattoo style and a tattoo size, and transmitting, using the hardware processor, a message one of accepting or declining the request. In another embodiment, the tattoo size is input by selecting a body area on a pre-partitioned virtual body model or pre-partitioned 3D body model. The method can also include the steps of determining an artist rate for a percent unit, using the hardware processor via dividing an estimated cost of the artist's services by a percentage of a sample of the body area of the tattoo, determining an artist time for a percent unit, using the hardware processor, via dividing the average of the plurality of the artist rates for a percent unit, determining a time associated with rendering the tattoo style, using the hardware processor, by multiplying the artist time for a percent unit by a percentage of the body area of the tattoo received from a recipient device, and transmitting a final quote to the computing device from the artist using the hardware processor, where the final quote is the hourly rate of the artist multiplied by the total of the artist rate for the percent unit. In an alternative embodiment, the method also includes the step of transmitting, using the hardware processor, a message one of accepting and declining the request. In yet another embodiment, the method also includes the step of providing, using the hardware processor, additional information comprising at least one of hourly rates, deposit requirement, aftercare instructions, and biographical information.

In one embodiment, the system and method of the present disclosure utilizes machine learning and also includes the steps of storing training data that comprises a plurality of training instances, each of which includes a plurality of feature values and a label that indicates whether the training instance pertains to the tattoo artist and tattoo style, and using one or more machine learning techniques to train a classification model based on the training data. This allows the system to more accurately determine styles, prices and quotes for artwork and tattoos and aids in creating more accurate quotes and seamless interactions between a user and an artist and helps schedule artwork and tattooing sessions.

Referring now to FIG. 2, a reference image user interface 200 presented on user computing device 104 is depicted, according to an exemplary embodiment. In one embodiment, user 102 provides server 112 with one or more reference images representing the tattoo design that user 102 desires. It is to be understood that the one or more reference images may be any applicable image format that accurately conveys the tattoo design that user 102 desires, and this may include but is not limited to JPEG files, TIFF files, PDF files, screenshots, computer aided design (CAD) files, Clip Studio files, or any other applicable mechanism configured to accurately present an image. In one embodiment, server 112 is configured to detect one or more components of the one or more images indicating the quality of the one or more images in order to ensure that artist 108 may properly analyze the one or more images to determine if they have the capability to render a tattoo based on the imported images. In one embodiment, server 112 is configured to verify that the one or more images uploaded by user 102 exceed a predetermined quality threshold based on the one or more image components in which if the predetermined quality threshold is not exceeded then server 112 prompts user 102 for a version of the one or more reference images that is of better quality.

Referring now to FIG. 3, a 3D-enabled user interface 300 comprising a virtual body model 302 is depicted on user computing device 104, according to an exemplary embodiment. In one embodiment, server 112 utilizes imported and/or live recorded images and videos of user 102 sourced from computing device 104 resulting in analysis of the dimensions of the anatomical structure of user 102. Server 112 composes virtual body model 302 based on the analysis, and partitions each body part of virtual body model 302 into the plurality of partitions and/or segments. In one embodiment, each partition of the plurality of partitions are configured to support interactions from user 102 and/or tattoo artist 108. For example, tattoo artist 108 may apply a base estimation for each of the plurality of partitions prior to a desired design being applied to the partition for preview. For example, artist tattoo 108 may establish a minimum base rate for an arm sleeve and user 102 may be notified of the minimum base rate once selecting the segment representing the arm of virtual body model 302. In one embodiment, user 102 and/or tattoo artist 108 is configured to tilt, rotate, and zoom in/out the virtual body model 302 in order to provide the viewer with 360 degrees viewing functionality. User 102 may apply the desired design to the applicable partition for preview purposes resulting in a plurality of options such as orientation, style, or any other factors associated with the desired design being presented to user 102 to select from. Based upon the selections by user 102, tattoo artist 108 accurately generates one or more tattoo estimates associated with rendering a tattoo of the desired design onto the segment selected by user 102. In one embodiment, server 112 is configured to generate an approximate estimate associated with the cost and the amount of time required for tattoo artist 108 to render the desired design on user 102 in real life.

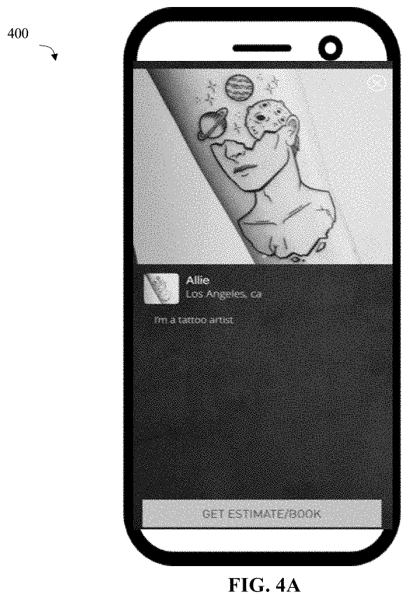

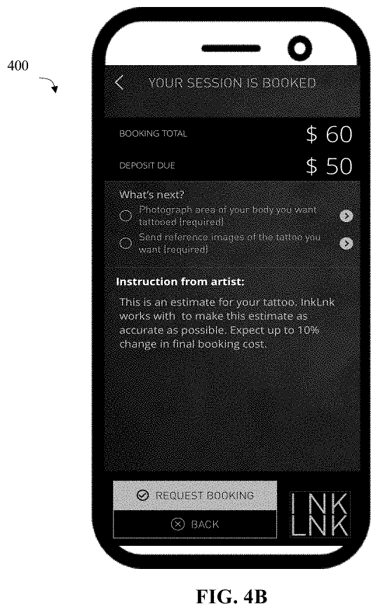

Referring now to FIG. 4, a list of tattoo artist profiles user interface 400 is depicted on user computing device 104, according to an exemplary embodiment. In one embodiment, user 102 may utilize interface 400 to view an aggregated list of a set of tattoo artists along with a subset of components associated with the set of tattoo artists. The subset of components may include but are not limited to artist biography, location, rates, artwork catalogues (maintained on database 114), specialty, techniques, or any other applicable information associated with tattoo artist 108 that may be useful to user 102 when determining whether to select a particular tattoo artist. In one embodiment, server 112 may determine the geographic location of user 102 and present to user 102 an aggregated set of a plurality of tattoo artist profiles associated with one or more tattoo artists 108 within a predefined proximity to the geographic location of user 102 along with a summarized version of noteworthy information associated with each tattoo artist 108.

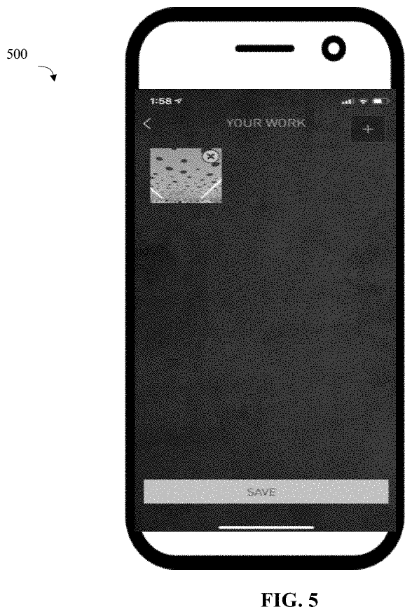

Referring now to FIG. 5, a tattoo artist catalogue user interface 500 is depicted on user computing device 104, according to an exemplary embodiment. In one embodiment, interface 500 presents images, videos, and any other applicable media associated with tattoo artist 108 depicting previous work that tattoo artist 108 has rendered. For example, user interface 500 may be utilized to inform user 102 about a particular tattoo artist's precautionary measures taken while rendering services in addition to information associated with recovery/aftercare and maintenance after the services are rendered. It is to be understood that the purpose of interface 500 to allow user 102 to browse artwork associated with tattoo artist 108 and gain an idea of the techniques, styles, and procedures of a particular tattoo artist to support the selection of the particular tattoo artist to render the tattoo on a particular body part.

Referring now to FIG. 6, an artist quote tool user interface 600 is depicted on artist computing device 108, according to an exemplary embodiment. In one embodiment, tattoo artist 108 determines the one or more estimates associated with rendering the previewed desired design on the applicable body part based on a plurality of factors that include but are not limited to time to render the desired design, complexity of the desired design, techniques utilized during the rendering process, and any other applicable factor taken into account in the tattoo rendering process. It is to be understood that artist quote tool user interface 600 is configured to allow tattoo artist 108 to generate the one or more estimates for user 102 based on a generated preview of the desired design on the applicable body part of user 102. In one embodiment, the one or more estimates may be updated based on additional information or adjustments to the reference images and/or the specification details associated with the desired design provided by user 102.

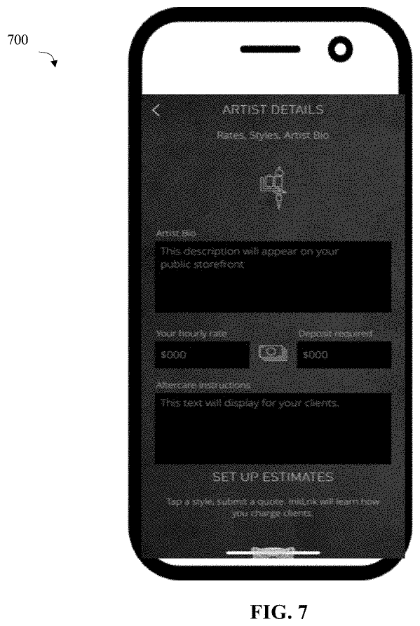

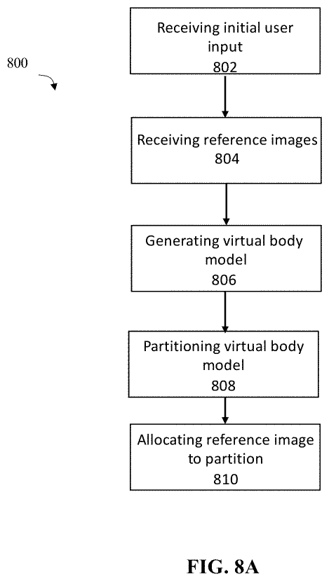

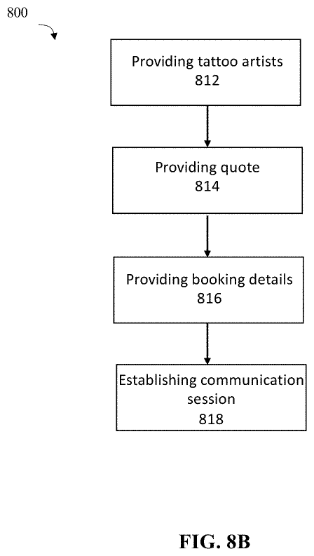

Referring now to FIG. 7, an artist detail user interface 600 is depicted on artist computing device 108, according to an exemplary embodiment. The artist detail user interface 600 allows server 112 to present a plurality of fields configured for tattoo artist 108 to provide information associated with but not limited to biography, hourly rate, deposit requirement, aftercare instructions, and any other applicable information configured to assist tattoo artist 108 with branding and marketing their services. In one embodiment, tattoo artist 108 may utilize artist detail user interface 600 to allocate the one or more estimates to a pre-existing virtual body model in which tattoo artist 108 sets a minimum rate for each body part associated with the plurality of partitions. Server 112 allows the minimum rate to be adjusted based on distinctions between the pre-existing virtual body model and virtual body model 302. For example, if the body frame of user 102 acquired from the images or live-recorded videos of user 102 appears to be significantly larger than the pre-existing virtual body model requiring a significantly greater amount of work for tattoo artist 108 due to a larger surface to cover then tattoo artist 108 may utilize artist detail user interface 600 to adjust the quote on the body part associated with the particular partition. Quote adjusting mechanisms and calculations performed by server 112 are described in greater detail in reference to FIGS. 8A-8B.

Referring now to FIGS. 8A-8B, a flow chart 800 illustrating an exemplary method for an interactive tattoo estimator and scheduler performed via data received on the user-side is depicted. At step 802, server 112 receives the initial user input provided by user 102 on computing device 104. As previously mentioned, user 102 provides at least one image, previously recorded video, and/or live-recorded video of their anatomical structure in order for server 112 to perform a comprehensive scan of the exterior body surface of user 102. For example, user 102 may utilize the at least one sensor (camera) of computing device 104 to capture images and/or videos of the full body both anterior and posterior of user 102. In a preferred embodiment, server 112 is configured to determine the dimensions of the anatomical structure of user 102 and if the initial user input is below a predetermined quality threshold in which server 112 may not accurately analyze the anatomical structure of user 102 then server 112 prompts user 102 for one or more supplemental images or videos ensuring that the dimensions associated with the anatomical structure of user 102 are accurate. It is to be understood that server 112 is configured to account for contours, location, and orientation associated with external body parts of user 102 based on the initial user input in order to properly represent the anatomical structure of user 102 in the virtual body model. At step 804, server 112 receives the one or more reference images from user 102 via reference image user interface 200 presented on user computing device 104 in which the one or more reference images depict at least a design that user 102 desires to be tattooed on his/her body. In one embodiment, user 102 may provide a budget reflecting a range or set amount that user 102 is willing to spend in order to have the desired design rendered as a tattoo. It is to be understood that user 102 may upload the one or more reference images via computing device 104 or user 102 may select the one or more reference images from database 114 comprising various catalogues of artwork associated with one or more tattoo artists. In one embodiment the presentation of the catalogues may be organized and presented based on factors such as but not limited to popularity, geographic location of tattoo artist 108 in respect to user 102, category of content associated with the design in the reference image, or any other applicable factor configured to assist user 102 in navigating an extensive catalogue of artwork. Furthermore, user 102 may be presented with a plurality of types of tattoos along with associated styles inherent to each type of tattoo. At step 806, server 112 generates 3-dimensional (3D) virtual body model 302 of user 102 based on the analysis performed on the initial user input. It is to be understood that virtual body model 302 is configured to accurately depict the anatomical structure of the exterior body parts of user 102 and each of the body parts associated with virtual body model 302 are configured to be selected by user 102 via 3D-enabled user interface 300. At step 808, server 112 partitions virtual body model 302 into a plurality of segments in which each of the segments of the plurality of segments represent a body part associated with user 102, and the segments are further configured to be allocated at least an estimate of the cost it would be to have the desired design rendered on the body part associated with the selected segment. It is to be understood that the segments of virtual body model 302 may comprise a base estimate rate associated with a particular tattoo artist 108 reflecting a minimum amount that tattoo artist 108 will charge for rendering the tattoo on the body part; however, various factors may be accounted for and utilized to adjust the minimum amount such as but not limited to size of the area associated with selected segment, complexity of the desired design, time necessary to complete the desired design, demand of tattoo artist 108, and any other applicable factor associated with tattoo artist 108 determining a rate for services. At step 810, server 112 allocates the one or more reference images reflecting the desired design for the tattoo to the selected segment of virtual body model 302 providing user 102 with the opportunity to observe a preview of how the desired design will look on the body of user 102. It is to be understood that the preview presented to user 102 may vary depending on not only the one or more reference images utilized, but also in some embodiments the one or more reference images may be received by tattoo artist 108 in which tattoo artist 108 may generate a personalized preview of the desired design on user 102 reflecting the styles, skills, and techniques of tattoo artist 108. However, other examples of preview presentation may also be used and are within the spirit and scope of the present invention.

At step 812, server 112 provides the list of tattoo artist profiles user interface 400 based upon the one or more tattoo artists 108 that are configured to render the desired design to user 102 as previewed. It is to be understood that selection and presentation of the list of tattoo artist profiles may be based upon a plurality of factors that include but are not limited to geographic location of tattoo artist 108 in respect to user 102, budget of user 102 in respect to cost of services for a particular tattoo artist 108, specific style associated with the one or more reference images, and any other applicable factor. However, other examples of filtration performed in order to ensure that the most applicable list of tattoo artist profiles are presented to user 102 are within the spirit and scope of the present invention. At step 814, server 112 provides one or more estimates/quotes in which each of the estimates/quotes represents a particular tattoo artist 108 and the amount their service cost in order to render the desired design as a tattoo on user 102. In one embodiment, each estimate is generated by server 112 based on the estimated cost of rendering the tattoo provided by tattoo artist 108 (represented by variable c) divided by an applicable percentage of surface area associated with the segment where the desired design is to be applied (represented by variable a) equating to 1% of the rate associated with tattoo artist 108 rendering the tattoo (represented by variable b). In other words, the formulaic expression of the aforementioned is c/a=b. Furthermore, server 112 determines the average of the compilation of b values associated with the plurality of tattoo artists 108 (represented by variable y) divided by the hourly rate associated with tattoo artist 108 (represented by variable r) equating to the number of hours required for tattoo artist 108 to render a 1% of the tattoo (represented by variable v), expressed formulaic as y/r=v. Furthermore, server 112 determines a percentage of surface area associated with the selected segment the desired design is applied to (represented by variable p) multiplied by the number of hours required for tattoo artist 108 to render a 1% of the tattoo (represented by variable v) equating to the total number of hours required by tattoo artist 108 to render the desired design (represented by variable t), expressed formulaic as v×p=t. Thus, a final quote for tattoo artist 108 to render the desired design (represented by variable q) equates to the hourly rate associated with tattoo artist 108 (represented by variable r) multiplied by the total number of hours required by tattoo artist 108 to render the desired design (represented by variable t), expressed formulaic as t×r=q.

In one embodiment, server 112 provides a percentage value for each of the one or more reference images indicating that the desired design consumes the amount equivalent to the percentage value of the body of user 102. For example, if the estimate generated by server 112 based on the estimated cost of rendering the tattoo provided by tattoo artist 108 (represented by variable c) equates to $200 and the applicable percentage of surface area associated with the segment where the desired design is to be applied (represented by variable a) equates to 1.5%, then 1% of the rate associated with tattoo artist 108 rendering the tattoo (represented by variable b) equates to $133.33 per 1%. Furthermore, the average of the compilation of b values associated with the plurality of tattoo artists 108 (represented by variable y) equates to $133.33 divided by the hourly rate associated with tattoo artist 108 (represented by variable r) equating to the number of hours required for tattoo artist 108 to render a 1% of the tattoo (represented by variable v), resulting in v equating to 0.888 hours per 1%. Furthermore, if p equates to 1.25%, then t equals 1.11 hours; thus, q the quote for hourly services of tattoo artist 108 equates to $166.50 per hour. At step 814, server 112 provides q to computing device 104 based on the selected segment. At step 816, server 112 provides a plurality of booking information subject to the particular tattoo artist 108 that user 102 selects based on the preference of provided q value. In one embodiment, step 818 may occur in which server 112 may establish a tele-communicative session between user 102 and selected tattoo artist 108 providing in user 102 to have an opportunity to ask particular questions associated with acquiring the desired design.

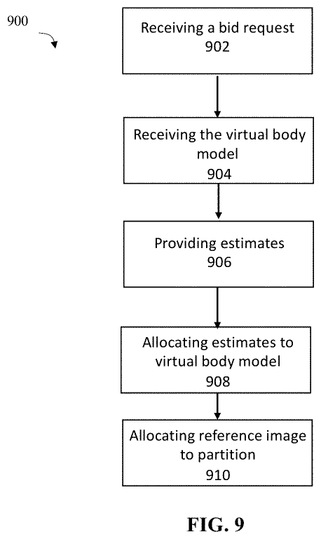

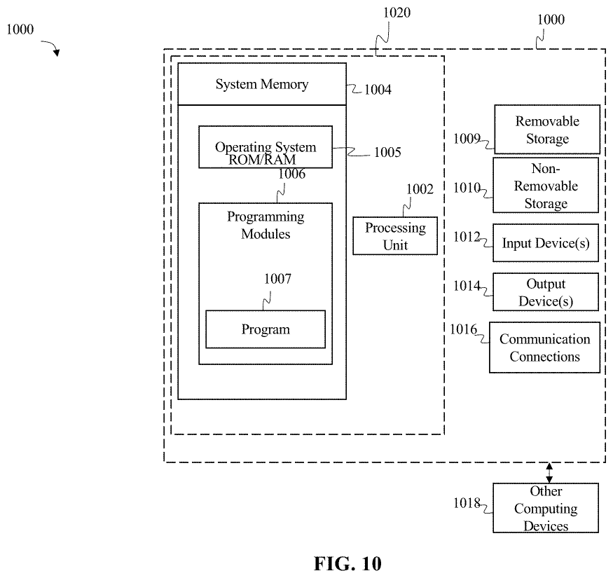

Referring now to FIG. 9, a flow chart 900 illustrating an exemplary method for an interactive tattoo estimator and scheduler performed via data received on the tattoo artist-side is depicted. At step 902, server 112 transmits to tattoo artist computing device 110 a bid request and/or notification indicating that user 102 has submitted the initial user input and/or reference images to the centralized platform. It is to be understood that tattoo artist 108 may be notified based on geographic proximity of tattoo artist 108 to user 102, a component of the catalogue of tattoo artist 108 being selected for the one or more reference images, or indications of one or more components of the desired design being within a particular specialized niche or skillset associated with tattoo artist 108. At step 904, tattoo artist 108 receives virtual body model 302 associated with user 102 allowing tattoo artist 108 to determine the selected segment and apply a rendition of the desired design on the selected segment configured for user 102 to preview. At step 906, tattoo artist 108 provides one or more estimates based on specifications associated with the desired design and selected segment, and server 112 utilizes the aforementioned formulaic expressions to generate q. In one embodiment, at step 908, tattoo artist 108 may provide one or more estimates for each of the segments associated with virtual body model 302 allowing tattoo artist 108 to provide a base estimate specific to each segment of virtual body model 302. At step 910, tattoo artist 108 renders a personalized rendition of the one or more reference images reflecting a tattoo artist-personalized version of the desired design associated with user 102 configured for preview on the segment of the virtual body model by user 102. It is to be understood that selection of tattoo artist 108 by the user 102 is based upon satisfaction of user 102 with the preview on the selected segment depicting the personalized rendition of the one or more reference images in which server 112 schedules a booking between user 102 and tattoo artist 108 once user 102 confirms the quote.

Computing device 1000 may also contain a communication connection 1016 that may allow system 100 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1004, including operating system 1002. While executing on processing unit 1002, programming modules 1006 (e.g. program module 1007) may perform processes including, for example, one or more of the stages of a process. The aforementioned processes are examples, and processing unit 1002 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

In one embodiment, server 112 may utilize a machine learning model or a rule-based model in order to generate predictions associated with tattoo artist 108 configured to be utilized by system 100. For example, if the model is a machine-learned model, then one or more machine learning techniques are used to “learn” weights of different features, which weights are then utilized by server 112 to generate one or more estimates associated with tattoo artist 108. The features associated with the weights include but are not limited to previous estimates rendered by tattoo artist 108 for services, styles/techniques associated with tattoo artist 108, time previously required to render services, or any other applicable data configured to facilitate automation of generating the final quote for user 102.

In one embodiment, server 112 is configured to generate a classification model generated based on training data utilizing the one or more aforementioned machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical that is trained based on a history of attribute values associated with data utilized within system 100. The machine-learned model is trained based on multiple attributes (or factors) described herein. In machine learning parlance, such attributes are referred to as “features”. In an embodiment, various feature weights or coefficients are established in order to accurately generate predictions for system 100. To generate and train a machine-learned model, a set of features is specified and training data is generated. In an embodiment, a new machine-learned model is generated regularly, such as every month, week, or other time period. Thus, the new machine-learned model may replace a previous machine-learned model. Newly acquired or changed training data may be used to update the model.

In one embodiment, a system for an interactive tattoo estimator and scheduler is presented. The system comprises a non-transitory memory storing an executable code; a hardware processor executing the executable code to: receive entries from at least one provider device describing at least one offered type of tattoo and at least one offered style of tattoo associated with the at least one offered type of tattoo, receive a selection from a recipient device of a body area for placement of a tattoo, receive a selection from the recipient device of a style of the tattoo, determine that offerings received from the at least one provider device meet the selections, transmit information associated with the determination to the recipient device, the information including estimates provided by the at least one provider device for tattoo services, receive a request from the recipient device for tattoo services described by the at least one provider device including placement of the tattoo, the request confirming the selections and choosing one of the estimates, transmit the request to the provider device, and receive from the provider device a response message one of accepting and declining the request.

In one embodiment, a system for an interactive tattoo estimator and scheduler is presented. The system comprises a non-transitory memory storing an executable code and an artist information database; a hardware processor executing the executable code to: receive a style input from a user; receive a tattoo size input from a user; determine an artist rate based on one or more artist specific style prices in the artist information database; and determine a quote price based on the tattoo size input and the artist rate.

In one embodiment, a method for use with a system for an interactive tattoo estimator and scheduler is presented. The system comprises a hardware processor and a non-transitory memory designed and configured to perform: transmitting, using the hardware processor, information describing at least one of offered types of tattoos and at least one style associated with each of the at least one offered type; transmitting, using the hardware processor, estimated prices for placement of at least one of the tattoo styles on a first part of a recipient body, the at least one tattoo style included in the at least one style associated with each of the at least one offered type; receiving, using the hardware processor, a request originated by a prospective tattoo recipient device for tattoo placement of the at least one offered style on the first part of the recipient body; and transmitting, using the hardware processor, a message one of accepting and declining the request.

In one embodiment, a method for use with a system for an interactive tattoo estimator and scheduler is presented. The system comprises a hardware processor and a non-transitory memory designed and configured to perform: transmitting, using the hardware processor, a selection of a tattoo parameter or parameters, receiving, using the hardware processor, a listing of providers of tattoo services, the providers offering services accommodating the selections and parameters, the listing further including estimated prices for the services; and transmitting, using the hardware processor, booking instructions for services including placement of a selected tattoo.

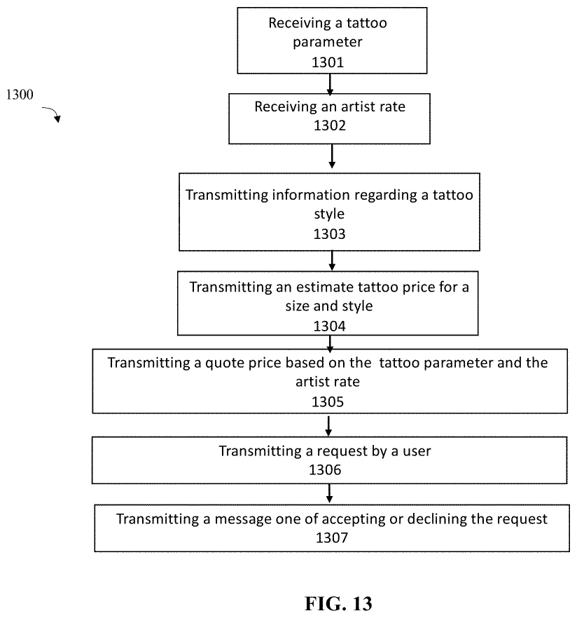

Referring now to FIG. 13, a flow chart 1300 illustrating an exemplary method for an interactive tattoo estimator and scheduler. At step 1301, the system 100 receives a tattoo parameter 1301, and receives an artist rate 1302. At step 1303, the system transmits information regarding a tattoo style, and transmits an estimate tattoo price for a size and style at step 1304. The system then transmits a quote price based on the tattoo parameter and the artist rate at step 1305, and at step 1306, transmits a request by a user. The system then transmits a message one of accepting or declining the request at step 1307.

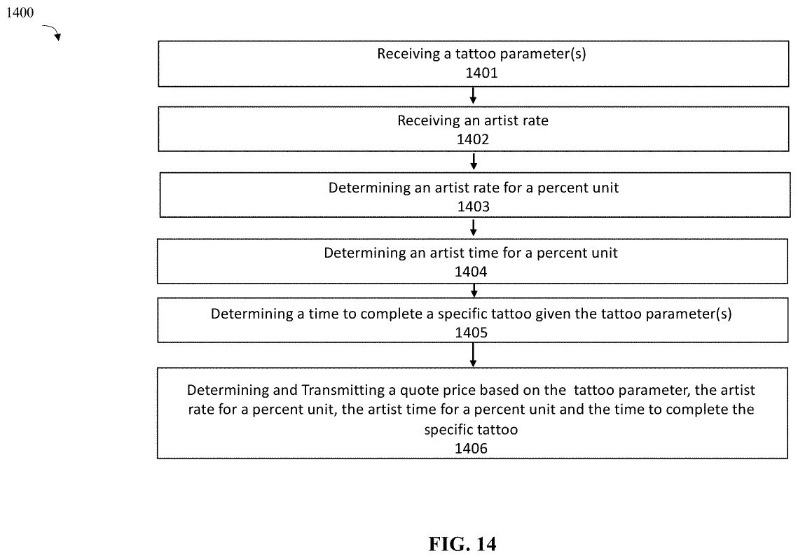

Referring now to FIG. 14, a flow chart 1400 illustrating an exemplary method for an interactive tattoo estimator and scheduler. At step 1401, the system 100 receives a tattoo parameter, and artist rate at step 1402. Based on that input, the system 100 determines an artist rate for a percent unit at step 1403, at step 1404, the system determines an artist time for a percent unit and a time to complete a specific tattoo given the tattoo parameter(s) at step 1405. The system then determines and transmits a quote price based on the tattoo parameter, the artist rate for a percent unit, the artist time for a percent unit and the time to complete the specific tattoo at step 1406.

While in some embodiments, the system 100 is used specifically for generating quotes and estimates for tattoos and is to be used by tattoo artists and artist client, in other embodiments, the system 100 is used for any type of art such as murals, paintings, sculpting or any work of artistic value. Referring now to FIG. 15, a flow chart 1500 illustrating an exemplary method for an interactive art estimator and scheduler. At step 1501, the system 100 receives an art parameter, and artist rate at step 1502. Based on that input, the system 100 determines an artist rate for a percent unit at step 1503, at step 1504, the system determines an artist time for a percent unit and a time to complete a specific art given the art parameter(s) at step 1505. The system then determines and transmits a quote price based on the art parameter, the artist rate for a percent unit, the artist time for a percent unit and the time to complete the specific art at step 1406.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. It is also understood that components of the system may be interchangeable or modular so that the components may be easily changed or supplemented with additional or alternative components.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system comprising:
a non-transitory memory storing an executable code and an artist information database;
a hardware processor executing the executable code to:
receive a user input selecting at least one tattoo parameter;
determine an artist rate based on one or more artist specific prices in the artist information database;
determine a quote price based on the tattoo parameter and the artist rate; and
transmit the quote price to the user.

2. The system of claim 1, wherein the tattoo parameter is at least one of a tattoo style, a tattoo size, a tattoo location on a body, a tattoo percent body area, a tattoo body partition, a tattoo body partition selected from a pre-partitioned virtual body model, a tattoo body partition selected from a pre-partitioned 3-dimensional virtual body model, and a tattoo body percent unit.

3. The system of claim 1, wherein the artist information database includes at least one of an artist hourly rate, an artist style, an artist estimate for a tattoo, an artist estimate for a style specific tattoo, an artist percent rate, an artist time to complete a tattoo body percent unity, an artist availability, an artist location, an artist review, an artist sample work, an artist portfolio, an artist deposit requirement, an artist instruction, and an artist biography.

4. The system of claim 1, wherein the non-transitory memory is further storing a tattoo library database wherein said tattoo library database comprises at least one tattoo sample including a predetermined tattoo style, a predetermined tattoo size, and a predetermined tattoo percent body area.

5. The system of claim 4, wherein the hardware processor executing the executable code further determines an artist rate for a percent unit based on an artist style price estimate for said tattoo sample and the predetermined tattoo percent body area.

6. The system of claim 4, wherein the hardware processor executing the executable code further determines an artist time for a percent unit based on one or more artist style price estimate for said tattoo sample and an artist hourly rate.

7. The system of claim 4, wherein the hardware processor executing the executable code further determines the artist rate for a percent unit based on an artist style price estimate for said tattoo sample and the predetermined tattoo percent body area, wherein the hardware processor executing the executable code further determines an artist time to complete a percent unit based on one or more artist style price estimate for said tattoo sample and an artist hourly rate and wherein the hardware processor executing the executable code further determines the quote price based on the artist rate for a percent unit, the artist time to complete a percent unit, the tattoo parameter and the artist rate.

8. The system of claim 1, wherein the hardware processor executing the executable code further receives an artist estimate for a given tattoo size and style and determines an artist rate for a percent unit.

9. The system of claim 1, wherein the hardware processor executing the executable code further receives an artist estimate for a given tattoo size and style and determines an artist time for a percent unit.

10. The system of claim 9, wherein the hardware processor executing the executable code further receives a tattoo parameter, determines a specific tattoo quote based on the tattoo parameter, the artist time for a percent unit and the artist rate for a percent unit and outputs the specific tattoo quote on a display.

11. The system of claim 10, wherein the hardware processor executing the executable code further allows the artist to accept or decline a user's request.

12. A system comprising:
a non-transitory memory storing an executable code and an artist information database;
a hardware processor executing the executable code to:
receive at least one art parameter input from a user;
determine an artist rate based on one or more artist specific prices in the artist information database;
determine a quote price based on the art parameter and the artist rate.

13. The system of claim 12, wherein the hardware processor executing the executable code further receives an art parameter, determines a specific art quote based on the art parameter, an artist time for a percent unit and the artist rate for a percent unit and outputs the specific art quote on a display.

14. A method for use with a system including a hardware processor and a non-transitory memory, the method comprising
a) receiving, by the hardware processor, a tattoo parameter;
b) receiving, by the hardware processor, an artist rate;
c) transmitting, using the hardware processor, a quote price based on the tattoo parameter and the artist rate.

15. The method of claim 14 including a client computer and further comprising the steps of:
a) receiving, using the hardware processor, information describing at least one tattoo style;
b) transmitting, using the hardware processor, estimated prices for a size of at least one of the tattoo styles;
c) receiving, using the hardware processor, a request originated by a prospective tattoo recipient device for a tattoo style and a tattoo size; and
d) transmitting, using the hardware processor, a message one of accepting or declining the request.

16. The method of claim 15, wherein the tattoo size is input by selecting a body area on a pre-partitioned virtual body model.

17. The method of claim 14, further comprising:
a) determining an artist rate for a percent unit, using the hardware processor via dividing an estimated cost of an artist's services by a percentage of a sample of a body area of a tattoo;
b) determining an artist time for a percent unit, using the hardware processor, via dividing an average of a plurality of the artist rates for a percent unit;
c) determining a time associated with rendering the tattoo style, using the hardware processor, by multiplying the artist time for a percent unit by a percentage of the body area of the tattoo received from a recipient device; and
d) transmitting a final quote to a computing device from the artist using the hardware processor, wherein the final quote is the hourly rate of the artist multiplied by a total of the artist rate for the percent unit.

18. The method of claim 14, further comprising the step of transmitting, using the hardware processor, a message one of accepting and declining a request.

19. The method of claim 14, further comprising:
providing, using the hardware processor, additional information comprising at least one of hourly rates, deposit requirement, aftercare instructions, and biographical information.

20. The method of claim 14, further comprising the steps of:
a) storing training data that comprises a plurality of training instances, each of which includes a plurality of feature values and a label that indicates whether the training instance pertains to the tattoo artist and tattoo style; and
b) using one or more machine learning techniques to train a classification model based on the training data.
